(19) United States
(12) Patent Application Publication
(10) Pub. No.: US 2026/0316782 A1
(43) Pub. Date: Oct. 15, 2026

(54) SYSTEM AND METHOD FOR OFFLINE 3D OBJECT DETECTION IN TRAFFIC SCENES USING LIDAR DATA WITH MULTIPLE RESOLUTIONS

(71) Applicant: Torc Robotics, Inc., Blacksburg, VA (US)

(72) Inventors: Dalong Li, Troy, MI (US); Syed Taha Shoaib, Macomb Township, MI (US); Xinxiang Zhu, Houston, TX (US); Marcus Badgett, Detroit, MI (US); Juncong Fei, Stuttgart, Nanz (DE)

(21) Appl. No.: 19/175,751

(22) Filed: Apr. 10, 2025

(51) Int. Cl. B60W 60/00; G06V 20/58; G06V 20/64

(52) U.S. Cl. CPC B60W 60/001; G06V 20/58; G06V 20/64; B60W 2420/408; B60W 2554/20; B60W 2554/40

(57) ABSTRACT

A system of an autonomous vehicle is described. The autonomous vehicle is configured to collect point cloud data associated with a current time, perform a dynamic object detection on the point cloud data to identify at least one dynamic object, and apply a dynamic object weight to the at least one dynamic object. The autonomous vehicle is further configured to retrieve point cloud data associated with at least one additional period of time, aggregate the point cloud data associated with the current time and the point cloud data associated the at least one additional period of time, perform a static object detection on the aggregated point cloud data to identify at least one static object apply a static object weight to the at least one static object, and generate a combined output of the at least one dynamic object and the at least one static object.

### TECHNICAL FIELD

The field of the disclosure relates generally to 3D object detection by an autonomy computing system of an autonomous vehicle and, more specifically, to object detection by processing multiple consecutive frames while compensating for motion.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system of an autonomous vehicle is described. The system includes one or more processors, and a memory coupled to the one or more processors storing machine readable instructions that, when executed by the one or more processors, configure the system to collect point cloud data associated with a current time, perform a dynamic object detection on the point cloud data to identify at least one dynamic object, apply a dynamic object weight to the at least one dynamic object, retrieve point cloud data associated with at least one additional period of time, aggregate the point cloud data associated with the current time and the point cloud data associated the at least one additional period of time, perform a static object detection on the aggregated point cloud data to identify at least one static object, apply a static object weight to the at least one static object, and generate a combined output of the at least one dynamic object and the at least one static object.

In another aspect, a computer implemented method is described. The method includes collecting point cloud data associated with a current time, performing a dynamic object detection on the point cloud data to identify at least one dynamic object, applying a dynamic object weight to the at least one dynamic object, retrieving point cloud data associated with at least one additional period of time, aggregating the point cloud data associated with the current time and the point cloud data associated the at least one additional period of time, performing a static object detection on the aggregated point cloud data to identify at least one static object, applying a static object weight to the at least one static object, and generating a combined output of the at least one dynamic object and the at least one static object.

In yet another aspect, a non-transitory computer-readable storage medium is described. The non-transitory computer readable medium includes instructions that, when executed by a computer, cause the computer to collect point cloud data associated with a current time, perform a dynamic object detection on the point cloud data to identify at least one dynamic object, apply a dynamic object weight to the at least one dynamic object, retrieve point cloud data associated with at least one additional period of time, aggregate the point cloud data associated with the current time and the point cloud data associated the at least one additional period of time, perform a static object detection on the aggregated point cloud data to identify at least one static object, apply a static object weight to the at least one static object, and generate a combined output of the at least one dynamic object and the at least one static object.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a depicts the autonomous truck shown in FIG. 1 in an example environment;

FIG. 4 is a schematic diagram of an example system for object detection;

FIG. 5 depicts a method for object detection;

FIG. 6 depicts example point cloud data of a dynamic object;

FIG. 7 depicts another example of point cloud data of a dynamic object;

FIGS. 8A-8D depicts an exemplary result set of an object detection method; and

FIG. 9 is a block diagram of an example computing system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Autonomous and semi-autonomous vehicles include sensors and the like which collect data from the surroundings of the vehicle. The sensor data can be processed by an autonomy computing system that controls the vehicle. In some instances, Light Detection and Ranging (LiDAR) sensor are used for object detection. LiDAR sensors generally include a laser generator and a detector that send and receive a LiDAR signal such that LiDAR point clouds (or “LiDAR images”) of the areas ahead of, to the side, behind, above, or below autonomous vehicle can be captured and represented in the LiDAR point clouds.

One challenge that arises in object detection is that the LiDAR point clouds in any one frame may be sparse and therefor, make it difficult to detect small object or objects which are small or far away. To increase the resolution of the point cloud, multiple consecutive frames can be merged. This may introduce other issues. For example, when multiple consecutive frames are merged, the resolution of stationary objects is increased, but motion introduced by the movement of the vehicle results in motion blurs in the point cloud. In other words, dynamic objects appear multiple times as the location of the dynamic object changes in sequential frames. In the present disclosure, dynamic objects are considered dynamic with reference to the motion of the vehicle. Therefore, a solution is needed which provides adequate resolution of stationary and dynamic objects in the point cloud.

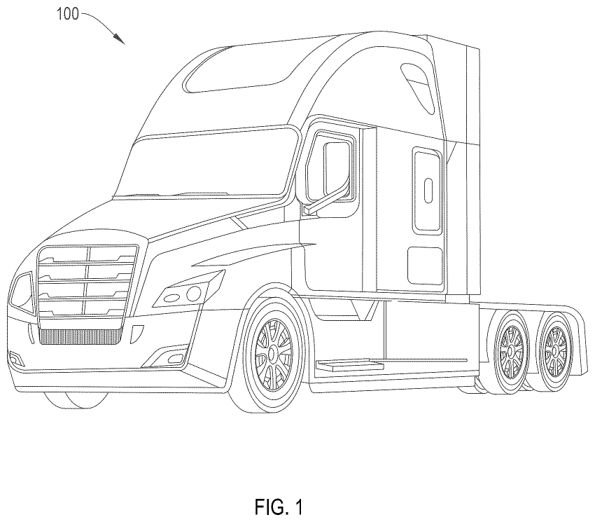

FIG. 1 illustrates a vehicle 100, such as a truck that may be conventionally connected to a single or tandem trailer to transport the trailer (not shown) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors.

While this disclosure refers to vehicle 100 (e.g., tractor trailer) as the automated vehicle, the automated vehicle could be any type of vehicle including an automobile, a mobile industrial machine, or the like. While the disclosure describes a self-driving or driverless autonomous system, the autonomous system could alternatively be semi-autonomous having varying degrees of autonomy or autonomous functionality.

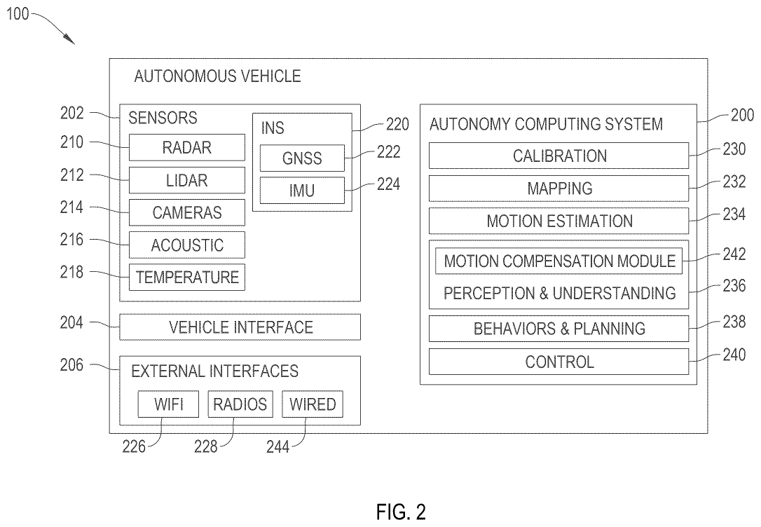

FIG. 2 is a block diagram of vehicle 100 shown in FIG. 1. The autonomous vehicle 100 further includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

As described above, LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a motion compensation module 242. The motion compensation module 242, for example, may be embodied within another module, such as perception and understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The motion compensation module 242 may perform one or more tasks including, but not limited to, processing point cloud data from a plurality of consecutive frames that compensate for dynamic objects in motion to prevent blurring, tailed artifacts, ghost objects etc. In some examples, non-consecutive frames may be used, wherein some frames may be skipped. In a process that will be described in further detail below, static objects are identified and represented by multiple consecutive frames of point cloud to increase resolution, whereas dynamic objects are identified and assigned a lower weight in a combined point cloud, i.e., a composite of the plurality of consecutive frames, to compensate for motion.

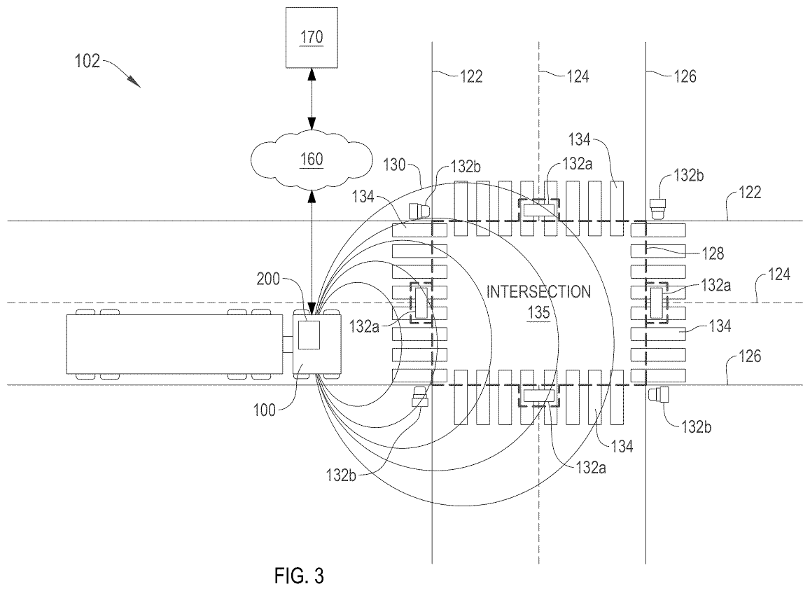

FIG. 3 shows a roadway environment 102, including various objects located at the roadway environment 102 and characteristics of roads intersecting at the roadway environment 102, according to an embodiment. The characteristics of the roads include an intersection 135, lane lines 122, 124, 126 and crosswalks 134 for pedestrians. Vehicle 100 is shown as an autonomous truck approaching the intersection 135, and vehicle traffic lights 132a and pedestrian traffic lights 132b (generally referred to as “traffic lights 132”) are situated around the intersection 135.

The autonomy computing system 200, as described above, of the autonomous vehicle 100 captures various types of information about the environment 102 and generates driving instructions for the autonomous vehicle 100. In some embodiments, various types of data or software components of the autonomy system may be stored or executed by a remote server 170, to which the autonomy computing system 200 reports via a network 160.

As described above, the autonomy computing system 200 includes the perception and understanding module 236 (sometimes referred to as perception components). The perception and understanding module 236 senses features of the roadway environment 102 surrounding vehicle 100 and interpret information related to the features. To interpret the surrounding roadway environment 102, the perception and understanding module 236 may identify and classify objects or groups of objects in the roadway environment 102. For example, the perception and understanding module 236 may identify one or more objects (e.g., pedestrians, vehicles, debris, etc.) and features of the roadway (e.g., lane lines 122, 124, and 126) and classify the objects and roadway features. As shown in FIG. 3, the perception and understanding module 236 of the autonomous vehicle 100 captures information about the roadway environment 102 with a perception radius 130.

As an example, as the vehicle 100 approaches an intersection 135, the perception module of the autonomy computing system 200 receives image data from the sensors 202, capturing data of roadway features, such as the traffic lights 132, crosswalks 134, and lane lines 122, 124, 126. The perception and understanding module 236 of the autonomy computing system 200 executes the object recognition and classification functions to identify and classify these roadway features. In some instances, the object recognition and classification function can determine whether an object is stationary or dynamic. When the object classification function detects a particular traffic light 132, the autonomy computing system 200 executes additional software components for classifying the status of the traffic light 132 (e.g., red, yellow, green). The autonomy computing system 200 then determines further driving operations according to the status of the traffic light (e.g., stop, slow down, continue), as well as other inputs.

As the vehicle 100 travels along the roadway, the autonomy computing system 200 may continually receive perception data from the various perception systems on the vehicle 100. The autonomy computing system 200 may receive, collect, and analyze the perception data periodically and/or continuously.

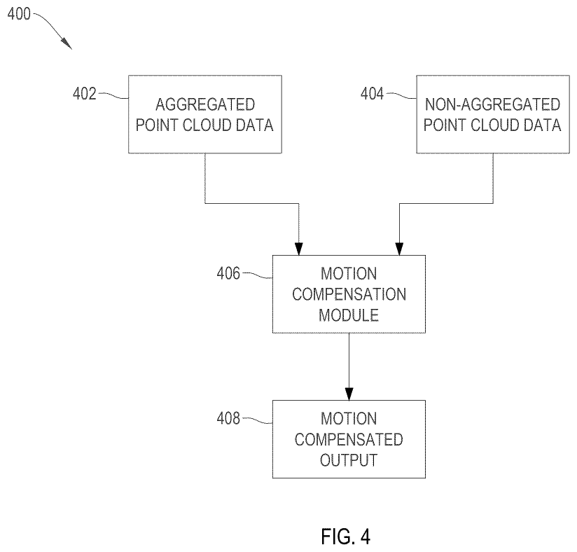

FIG. 4 depicts a schematic diagram of a system 400 for object detection using LiDAR data of multiple frames. As will be described further detail below, aggregated point cloud data 402 and non-aggregated point cloud data 404 are input into a motion compensation module 406. Motion compensation module 406 maybe substantially similar to and perform similar functions as motion compensation module 242 shown in FIG. 2. The non-aggregated point cloud data 404 includes point cloud data of a single frame and the aggregated point cloud data 402 includes point cloud data of multiple consecutive frames. The motion compensation module 406 outputs a motion compensation output 408. The motion compensated output 408 reduces artifacts introduced by the ego motion of the vehicle 100.

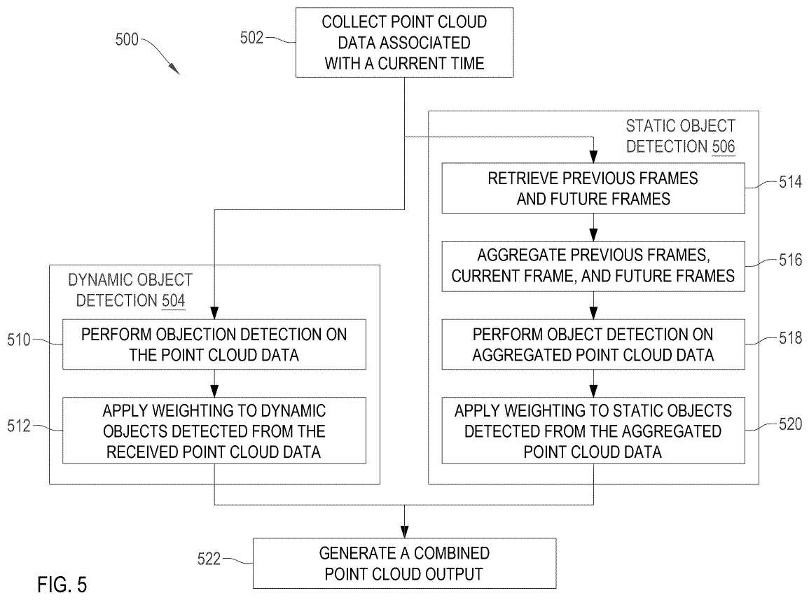

FIG. 5 depicts a method 500 for object detection and ego motion compensation. The method 500 may be carried out, for example, by the motion compensation module 242 shown in FIG. 3 or by the motion compensation module 406 shown in FIG. 4. The method 500 includes a dynamic object detection 504 branch and a static object detection 506 branch.

The method 500 includes collecting 502 point cloud data associated with a current time. The point cloud data represents one frame at a singular point in time. Next, in the dynamic object detection 504 branch, object detection is performed 510 on the point cloud data and a weight is applied 512 to the dynamic objects detected from the received point cloud data. In the dynamic object detection 504 branch, a singular frame is considered once an object is determined to be dynamic to prevent motion artifacts in the final combined point cloud.

The static object detection 506 branch includes retrieving 514 previous and future frames of point cloud data. The method 500 then further includes aggregating 516 previous frames, the current frame, and future frames. In other words, if a frame is selected as the current frame at t=0, frames at t=−3 t=−2 and t=−1 are aggregated with frames at t=0, t=1, t=2, and t=3. The method further includes performing 518 object detection on the aggregated point cloud data, and applying 520 weighting to static objects detected from the aggregated point cloud. In some examples, the weight applied to static objects may be greater than the weight applied to dynamic objects. In this way, the static objects within the aggregated point cloud data are sharpened by the added resolution of the consecutive frames included in the aggregated point cloud data. Alternatively, the dynamic objects, which may create motion artifacts in the aggregated point cloud data due to the fact that the object is in a different location during consecutive frames, are given less priority and are effectively filtered out. This improves the resolution of static objects, while limiting artifacts caused by dynamic objects.

In a final step, the weighted point cloud data generated by the dynamic object detection 504 branch and the weighted point cloud data generated by the static object detection 506 branch are combined, or summed, to generate 522 a combined output.

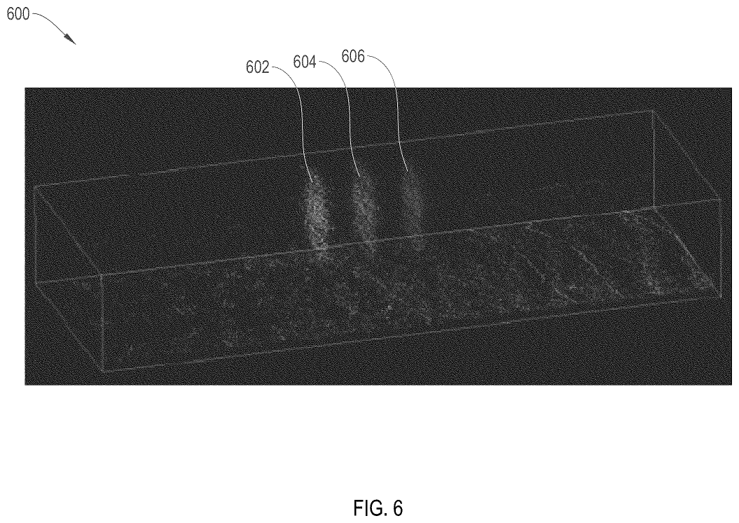

FIG. 6 depicts an example aggregated point cloud 600 of a dynamic object. The dynamic object is shown at a first time 602, a second time 604 and a third time 606. As is demonstrated by the aggregated point cloud 600 of FIG. 6, an object in motion creates blurring, tailed artifacts, ghost objects etc. and is undesirable. These artifacts make it difficult for the perception system to interpret the objects in the environment accurately.

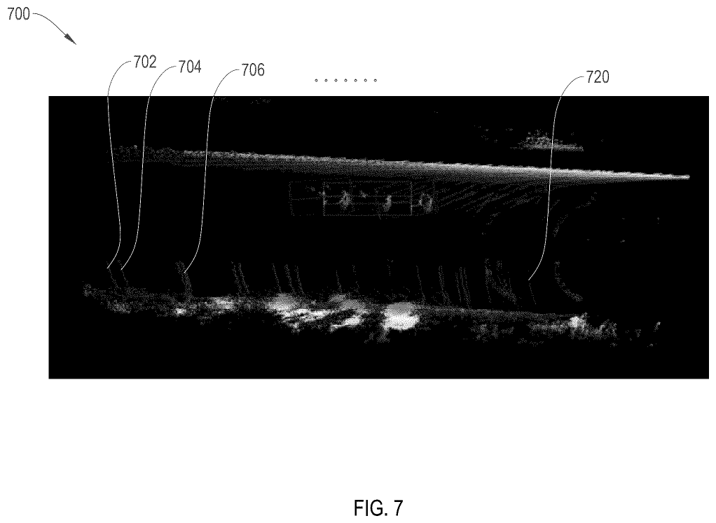

FIG. 7 depicts another example of aggregated point cloud data 700 of a dynamic object. Similarly, a dynamic object is shown at a first time 702, a second time 704, a third time 706, and several additional times up to an nth time 720. As described above, the object depicted in FIG. 7 is in motion, and as a result, it shows up multiple times in multiple locations within the aggregated point cloud data 700.

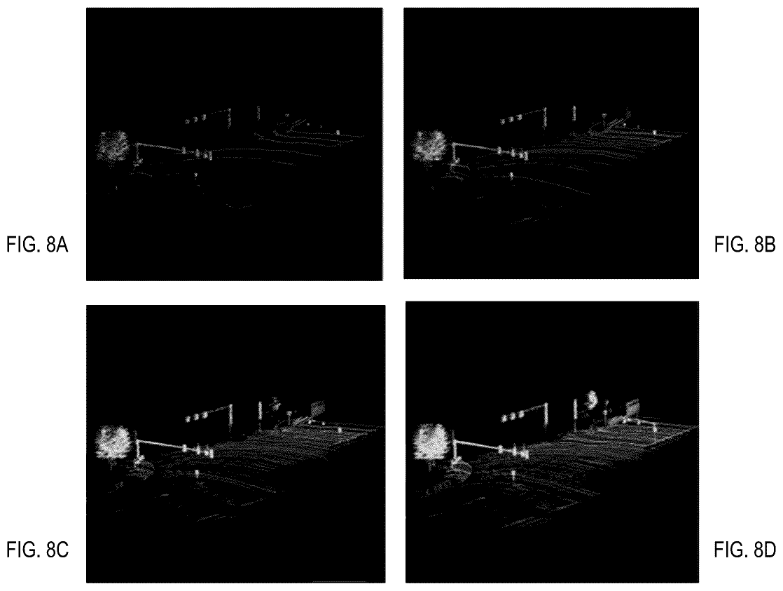

FIGS. 8A-8D depict an example result set by implementing the disclosed method of motion compensated object detection, such as method 500 shown in FIG. 5. FIG. 8A is a single frame that has undergone motion compensation. The quality depicted in FIG. 8A is sparse and not well defined. Specifically, objects which are small or far away are difficult to define within FIG. 8A. FIG. 8B has been aggregated using the disclosed method of motion compensated object detection using a first number of frames. As a result, FIG. 8B depicts an improved image quality, including more definition of objects, compared to FIG. 8A. FIG. 8C has been aggregated using the disclosed method of motion compensated object detection with a second number of frames which is higher than the first number of frames. As a result, FIG. 8C depicts an improved image quality over FIGS. 8A and 8B. For example, objects are more defined and clearly identifiable. Finally, FIG. 8D has been aggregated using the disclosed method of motion compensated object detection with a third number of frames which is higher than the second number of frames. As a results, FIG. 8D has an improved image quality over FIGS. 8A, 8B, and 8C. No artifacts are included from dynamic objects and the image as a whole has improved definition and resolution.

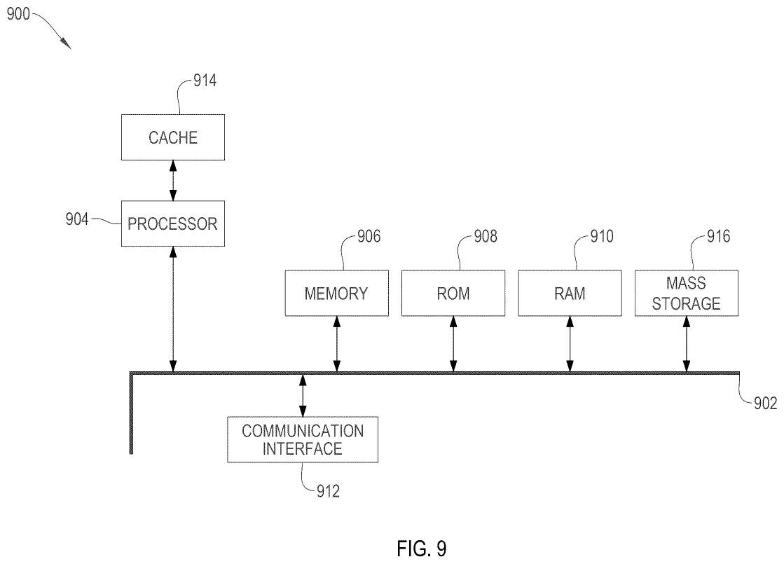

FIG. 9 illustrates an example computing system 900 that can implement various techniques, processes, functions, or methods described herein. The components of computing system 900 are shown in electrical communication with each other using a communication bus 902. The example computing system 900 includes a processor (CPU or processing unit) 304 coupled with communication bus 902 that couples various additional components to processor 904, including a memory 906, a read only memory (ROM) 908, and a random access memory (RAM) 910, and at least one communication interface 912. Communication interface 912 may include one or more additional components, such as integrated circuits, transceivers, transmitters, receivers, controllers, etc., for transmitting or receiving data over a channel. Such channels may include wired channels such as a serial channel, CAN bus, Ethernet or the like, or wireless channels employing protocols such as WiFi, Bluetooth, NFC, or other suitable wireless technologies.

In certain embodiments, as shown in FIG. 9, computing system 900 includes a cache 914 of high-speed memory connected directly with, in close proximity to, or integrated as part of processor 904. Computing system 900, in certain implementations, may copy data from memory 906 and/or a mass storage 916, also coupled with communication bus 902, to cache 914 for quick access by processor 904. In this way, cache 914 can improve performance of computing system 900 by reducing delays in processor 904 reading or writing data. These and other modules can store machine executable instructions for controlling, or configuring, processor 904 to perform various actions. Memory 906 can include multiple different types of memory with different performance characteristics. Processor 904 can include any general purpose processor, central processing unit (CPU), or graphics processing unit (GPU) in combination with a hardware or software provision configured to control processor 904. Such a software provision may be stored in memory 906, ROM 308, RAM 910, or mass storage 916. Processor 904 may, in certain embodiments, include a special-purpose processor where software instructions are incorporated into the processor design. Processor 904 may be a self-contained system, containing multiple cores or processors, a bus, memory controller, cache, etc. A multi-core processor may be symmetric or asymmetric.

Mass storage 916 is a non-volatile memory and can be one or more of a hard disk or other types of computer readable media that can store data that are accessible by a computer, such as a magnetic cassette, flash memory card, solid state memory device, digital versatile disk, cartridge, RAM, ROM, or hybrids thereof. Memory 906 or mass storage 916 can include machine executable instructions, software, code, firmware, etc., for controlling processor 904. In certain embodiments, processor 904 may be programmed, or configured, by encoding an operation or function using one or more machine executable instructions and providing the executable instructions in, for example, memory 906, ROM 908, RAM 910, or mass storage 916.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) improved detection of small or far away objects (b) improved detection of objects in motion or dynamic objects or (c) improved aggregated point clouds which accurately and precisely depict static and dynamic objects.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more machine executable instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An autonomy computing system of an autonomous vehicle, the autonomy computing system comprising:
one or more processors; and
a memory coupled to the one or more processors storing machine readable instructions that, when executed by the one or more processors, configure the one or more processors to:
receive first point cloud data associated with a current time;
perform a dynamic object detection on the first point cloud data to identify at least one dynamic object;
apply a dynamic object weight to the at least one dynamic object;
retrieve second point cloud data associated with a second period of time;
aggregate the first point cloud data associated with the current time and the second point cloud data associated the second period of time;
perform a static object detection on aggregated point cloud data to identify at least one static object;
apply a static object weight to the at least one static object; and
generate a combined output point cloud including the at least one dynamic object and the at least one static object.

2. The autonomy computing system of claim 1, wherein the second period of time is a period immediately preceding the current time or a period immediately following the current time.

3. The autonomy computing system of claim 1, wherein at least one of the first point cloud data or the second point cloud data is received by a Light Detection and Ranging (LiDAR) sensor.

4. The autonomy computing system of claim 1, wherein the static object weight is greater than the dynamic object weight.

5. The autonomy computing system of claim 1, wherein the combined output point cloud is utilized by a behaviors and planning module to execute at least one maneuver of the autonomous vehicle.

6. The autonomy computing system of claim 1, wherein the at least one static object is at least one of a traffic cone or a traffic light.

7. A method of object detection on an autonomous vehicle, the method comprising:
receiving first point cloud data associated with a current time;
performing a dynamic object detection on the first point cloud data to identify at least one dynamic object;
applying a dynamic object weight to the at least one dynamic object;
receiving second point cloud data associated with a second period of time;
aggregating the first point cloud data associated with the current time and the second point cloud data associated the second period of time;
performing a static object detection on aggregated point cloud data to identify at least one static object;
applying a static object weight to the at least one static object; and
generating a combined output point cloud of the at least one dynamic object and the at least one static object.

8. The method of claim 7, wherein the second period of time is a period immediately preceding the current time or a period immediately following the current time.

9. The method of claim 7, wherein at least one of the first point cloud data or the second point cloud data is collected by a Light Detection and Ranging (LiDAR) sensor.

10. The method of claim 7, wherein the static object weight is greater than the dynamic object weight.

11. The method of claim 7, wherein the combined output point cloud is utilized by a behaviors and planning module to execute at least one maneuver of the autonomous vehicle.

12. The method of claim 7, wherein the at least one static object is at least one of a traffic cone or a traffic light.

13. An autonomous vehicle comprising:
one or more sensors; and
an autonomy computing system comprising one or more processors and a memory coupled to the one or more processors storing machine readable instructions that, when executed by the one or more processors, configure the one or more processors to:
collect, via the one or more sensors, first point cloud data associated with a current time;
perform a dynamic object detection on the first point cloud data to identify at least one dynamic object;
apply a dynamic object weight to the at least one dynamic object;
collect, via the one or more sensors, second point cloud data associated with a second period of time;
aggregate the first point cloud data associated with the current time and the second point cloud data associated the second period of time;
perform a static object detection on aggregated point cloud data to identify at least one static object;
apply a static object weight to the at least one static object; and
generate a combined output point cloud of the at least one dynamic object and the at least one static object.

14. The autonomous vehicle of claim 13, wherein the second period of time is a period immediately preceding the current time or a period immediately following the current time.

15. The autonomous vehicle of claim 13, wherein at least one of the first point cloud data or the second point cloud data is collected by a Light Detection and Ranging (LiDAR) sensor.

16. The autonomous vehicle of claim 13, wherein the static object weight is greater than the dynamic object weight.

17. The autonomous vehicle of claim 13, wherein the combined output point cloud is utilized by a behaviors and planning module to execute at least one maneuver of the autonomous vehicle.

18. The autonomous vehicle of claim 13, wherein the at least one static object is at least one of a traffic cone or a traffic light.
